(19) United States
(12) Patent Application Publication
(10) Pub. No.: US 2007/0147816 A1
(43) Pub. Date: Jun. 28, 2007

(54) Camera modules with liquid optical elements

(75) Inventors: Giles Humpston, Aylesbury (GB); Kenneth Allen Honer, Santa Clara, CA (US)

Correspondence Address: TESSERA;LERNER DAVID et al., 600 SOUTH AVENUE WEST, WESTFIELD, NJ, 07090, US

(73) Assignee: Tessera, Inc., San Jose, CA (US)

(21) Appl. No.: 11/318,874

(22) Filed: Dec. 27, 2005

(51) Int. Cl. G03B 17/00

(52) U.S. Cl. 396/72

(57) ABSTRACT

An electronic camera module includes a lens or refractive element formed by a pair of immiscible liquids and having optical properties which can be varied by applying a voltage so as to deform the meniscus. One of the two liquids extends from the meniscus all the way to the front surface of the sensor, so that light passing through the meniscus does not encounter further changes in refractive index enroute to the sensor.

### BACKGROUND OF THE INVENTION

The present invention relates to electronic cameras and to methods and intermediate structures useful in forming the same.

An electronic camera module includes an optoelectronic sensor which includes an array of sensitive elements capable of converting light to electrical signals and optical elements for focusing an image of a scene to be captured onto the array. Most commonly, the sensor includes a semiconductor imaging chip incorporating charged coupled device (“CCD”) elements or other optically sensitive elements such as p-n junctions in a CMOS structure. Each element is capable of capturing one picture element or “pixel” of the image. The imaging chip typically also includes conventional circuitry for converting the signals from the elements into a stream of data representing the image. The sensor may include either an imaging chip alone or an imaging chip together with a transparent cover which protects the sensitive elements from dust particles. There has been substantial progress in development of such sensors during the last few years; modern sensors may incorporate hundred of thousands of elements or “pixels” within a few square centimeters of chip surface area. Therefore, it has become practicable to incorporate digital cameras into devices such as cellular telephones, personal digital assistants or “PDAs” and the like. Camera modules for incorporation in such devices should be both compact and economical to manufacture.

As the size of sensors has diminished, and their capability has increased, there has been an increasing demand for improvements in the associated optical components such as lenses and in the structures and techniques used for mounting the optical components in position relative to the sensors. Moreover, the sensors and optical components must be mounted to elements of a larger assembly. Typically, the sensor is electrically connected to a printed circuit board or other circuit panel using techniques such as wire-bonding or surface-mounting. The design of the optical components and supporting structures must accommodate such electrical connections and must fit within a small volume and within a small area on the circuit panel.

It has been proposed heretofore to provide electronic cameras with so-called liquid lenses. As described, for example, in Kuiper et al., “Wet and Wild,” SPIE OEMagazine, January 2005, it has been proposed to provide a lens having a refractive interface defined by two immiscible liquids in a container. One of these liquids typically is an electrically conductive liquid such as salt water, whereas the other liquid typically is a dielectric liquid such as a silicone oil. The two liquids have different refractive indices. Electrodes are provided in proximity to the container, with one electrode in contact with the conductive liquid, and with the opposite electrode extending along the circumferential wall of the container. The circumferential electrode is covered by a thin film of a dielectric solid. An electrical potential applied between the electrodes causes a phenomenon known as electrowetting, which, in turn, causes a change in the curvature of the interface or meniscus formed by the immiscible liquids. This, in turn, changes the curvature of the refractive interface. Such a structure provides an optical element having refractive properties which vary with the applied voltage. As described in the aforementioned Kuiper et al. article, such a refractive element can be used to provide a compact variable focus optical system for an electronic camera.

### SUMMARY OF THE INVENTION

One aspect of the invention provides a camera module. The module according to this aspect of the invention desirably includes an optoelectronic sensor. The sensor includes a body having a front surface and an array of optically sensitive elements arranged so that light impinging on said front surface will pass to said optically sensitive elements. For example, the sensor body may include a semiconductor chip either alone or together with a cover overlying the chip so that the cover defines the front surface of the sensor body. The module according to this aspect of the invention desirably also has a lens assembly. The lens assembly includes a first liquid in contact with the front surface of the sensor body and an element having index of refraction different from the index of refraction of said first liquid forming a refractive interface with the first liquid. Preferably, the second element includes a second liquid having an index of refraction different from the first liquid. The liquids form a curved meniscus therebetween and this meniscus constitutes the refractive interface. Desirably, the module further includes electrodes in proximity to the first and second liquids, the electrodes and the liquids being arranged so that the curvature of the meniscus can be altered by varying an electrical potential between the electrodes.

Because the first liquid extends from the refractive interface to the front surface of the sensor body, the light passing from the refractive interface to the sensor need not pass through additional interfaces. This minimizes spurious reflections and glare in the optical path. Moreover, the liquid optical path enhances the focusing capability of the lens system.

A further aspect of the invention provides methods of making camera modules. The method according to this aspect of the invention desirably includes assembling a container element including a plurality of containers with a wafer element including a plurality of image sensor chips so that the containers are aligned with sensing elements of the chips. The method desirably further includes filling each container with two immiscible liquids having different indices of refraction to thereby form a meniscus, the meniscus defining a refractive interface. Most preferably, the method includes the step of severing the container element and the wafer element to thereby form a plurality of individual units, each including one of the image sensor chips and one of the containers.

### BRIEF DESCRIPTION OF THE DRAWINGS

FIG. 1 is a diagrammatic sectional view depicting a camera module according to one embodiment of the present invention.

FIG. 2 is a diagrammatic top plan view of the module shown in FIG. 1.

FIG. 3 is a detail view on an enlarged scale of a portion of the module shown in FIGS. 1 and 2.

FIG. 4 is a diagrammatic sectional view depicting the module of FIGS. 1-3 in conjunction with other components.

FIG. 5 is a fragmentary sectional view depicting portions of components used in manufacture of the module of FIGS. 1-3, during one stage of manufacture.

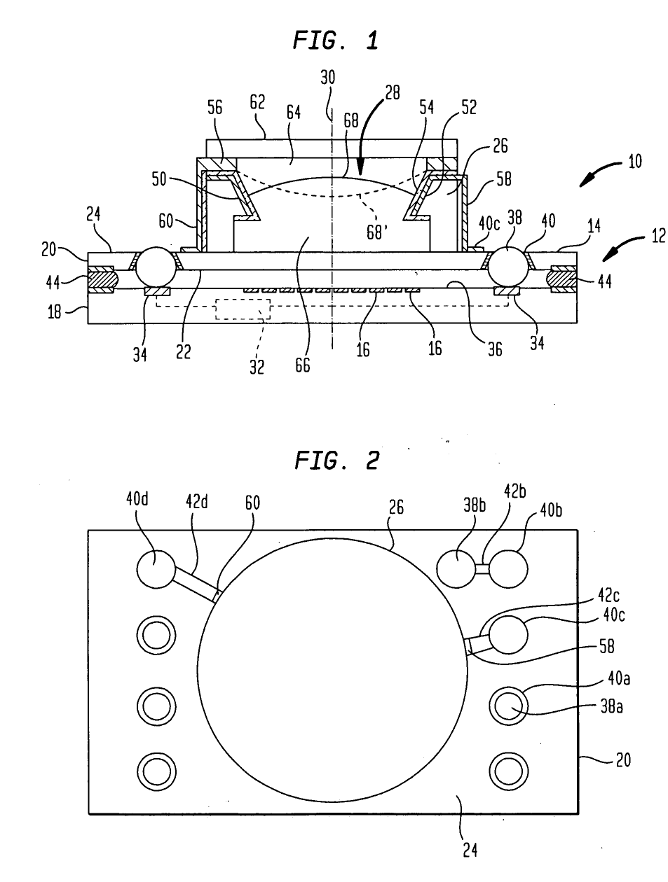

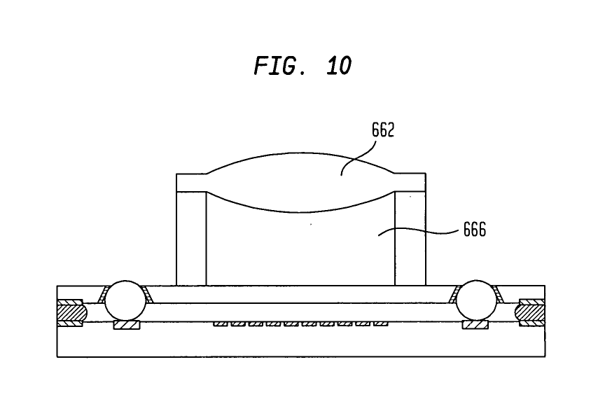

Each of FIGS. 6-10 is a view similar to FIG. 1 but depicting a module according to a different embodiment of the invention.

### DETAILED DESCRIPTION

A camera module 10 (FIG. 1) according to one embodiment of the invention includes an optoelectronic sensor 12. The sensor has a body which includes a front surface 14 and an array of optically sensitive elements 16 such as CCD imaging cells arranged so that light impinging on the front surface 14 will pass to these optically sensitive elements. In the particular embodiment depicted in FIG. 1, the sensor body includes a semiconductor chip 18 and a cover 20 which is transparent, at least in those regions aligned with optically sensitive elements 16. Cover 20 typically is formed from glass or a transparent polymer. Cover 20 has an inner surface 22 facing toward chip 18 and an outer surface 24 facing away from the chip. A generally cylindrical, tubular container wall 26 projects from the outer surface 24 of cover 20. Container wall 26 may be formed integrally with cover 20, or may be assembled. The container wall 26 defines a generally cylindrical space 28 having an axis 30 which is aligned with the center of the array of sensing elements 16.

Chip 18 includes electrical circuitry schematically indicated at 32 connected to optically sensitive elements 16 for driving the sensitive elements and processing the signals from the sensitive elements into a desired form for output from the chip. For example, in the case of a typical CCD imaging chip, circuitry 32 is arranged to actuate the actual charge coupled device cells cyclically and to read out the signals from the numerous cells in order, according to rows and/or columns. The circuitry is also arranged to convert these signals into digital form so that the output signals include a series or parallel data stream with digital bytes of information denoting the intensity of light received by the various pixels. If the chip is a color imaging chip, the chip may include wavelength-sensitive filters on some or all cells. The particular circuitry and internal structure of the chip may be entirely conventional, and accordingly is not further described herein.

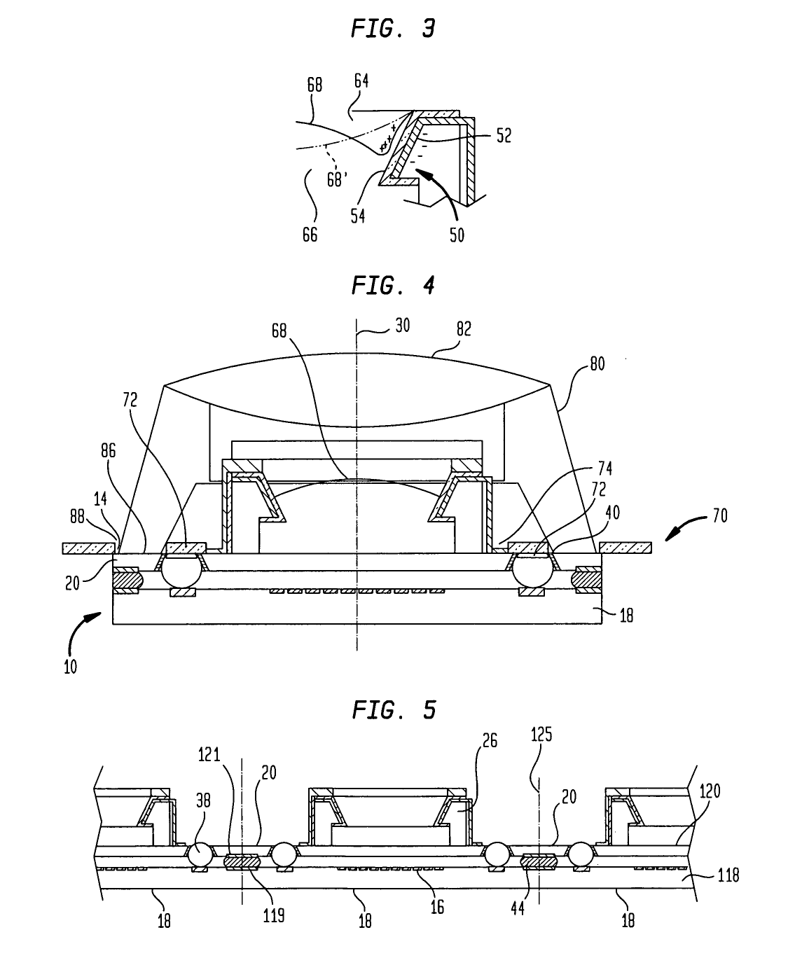

The circuitry of the chip is connected to contacts 34, which, in this embodiment, are disposed on the front surface 36 of the chip, i.e., the surface bearing sensitive elements 16 and facing toward the cover 20. Contacts 34 are electrically connected by through conductors 38 to electrical terminals 40 exposed at the outer surface 24 of the cover. The through conductors 38 themselves may form a part or all of the exposed terminals. Also, as used in this disclosure, a terminal “exposed at” a surface of a dielectric element may be flush with such surface; recessed relative to such surface; or protruding from such surface, so long as the terminal is accessible for contact by a theoretical point moving towards the surface in a direction perpendicular to the surface. As described, for example, in co-pending, commonly assigned U.S. patent application Ser. No. 10/949,764, the disclosure of which is incorporated by reference herein, the through conductors may include elements such as solid metallic spheres, solder connections or other metallic elements. Also, terminals 40 may be disposed at the same locations as through conductors 38, or at different locations. For example, as best seen in FIG. 2, terminals 40a is concentric with through conductor 38a, whereas terminal 40b is offset from a through conductor 38b and is connected to the through conductor by a trace 42b. Moreover, some of the terminals may not be connected to contacts 34, and some of the contacts 34 may not be connected to terminals. Terminals 40 and through conductors 38 desirably are disposed in peripheral regions of the chip and cover, outside of a central region enclosed by container wall 26.

A seal 44 extends between the cover 20 and semiconductor chip 18. As further discussed below, this seal may be formed in the same process as is used to apply the cover. The seal desirably extends around the entire periphery of the chip and cover. The through conductors and seal desirably are arranged so that the outer surface 24 of the cover is precisely parallel to the front surface 36 of the chip to within a close tolerance.

Container wall 26 has a tapered portion 50 sloping inwardly towards axis 30 in the rearward or downward direction, towards chip 18 (the direction towards the bottom of the drawing as seen in FIG. 1). In other embodiments, the direction of the slope may be reversed from the direction shown, so that the container wall slopes inwardly toward the axis in the forward or upward direction. An electrode 52 covers the sloping portion 50 and extends around the entire periphery of the container. The electrode, in turn, is covered by a dielectric coating 54. Electrode 52 may be a discrete metallic element or may be a metallic or other conductive coating applied on the surface of the sloping wall portion 50. Dielectric 54 most desirably is as thin as possible, while providing a pinhole-free dielectric coating having dielectric strength sufficient to withstand the voltages to be applied in service, typically on the order of a few hundred volts or less, as discussed below. Also, the dielectric coating most preferably is a coating which is hydrophobic, i.e., which is not normally wetted by water. For example, dielectric coating 54 may include a conformal coating, as, for example, a polyparaxylene or other vapor-deposited coating a few microns thick. The dielectric coating 54 may include a fluoropolymer or a polymer having a substantial preponderance of alkyl moieties at its surface. In one example, the dielectric coating includes a parylene-N coating covered by a fluoropolymer.

A further electrode 56 is exposed to the interior of bore 28 at one end of the tapered section. Electrode 52 is connected to a terminal 40c (FIG. 2) by a trace 42c extending along the outer surface 24 of cover 20, and by a conductor 58 extending along the container wall at one point on the periphery of the container wall. Electrode 56 is connected via a separate conductor 60 and trace 42d to a different terminal 40d on the cover. A transparent closure 62 extends across bore 28 at the end of the bore, remote from cover 24.

Two immiscible liquids 64 and 66 are disposed within bore 28. Liquid 64, disposed in contact with electrode 56 desirably is an aqueous, electrically conductive liquid such as a saline solution. Liquid 66, disposed in the rearward portion of bore 28 most preferably is a silicone oil such as a phenylated silicone oil. The two liquids most preferably have substantially equal specific gravity or density. The two liquids have different indices of refraction. The immiscible liquids cooperatively define a meniscus or curved interface 68. Because the two liquids have different refractive indices, meniscus 68 serves as a refractive interface which alters the focus of light passing through the bore 28 enroute to sensitive elements 16. The nature and degree of this change, of course, will depend upon the curvature of the meniscus. Meniscus 68 is the refractive interface closest to the front surface 14 of the sensor. For that reason, meniscus 68 may be referred to as the “proximal” refractive interface. Liquid 66, which forms part of the refractive interface, is also in contact with the front surface 14 of the sensor, i.e., the outer surface 24 of the cover. Therefore, light passing from refractive interface 68 passes through the liquid 66 to the front surface of the sensor without encountering any additional refractive interfaces. Because one of the liquids 66 defining the proximal refractive interface 68 is in contact with the front surface 14 of sensor 12, light passing from interface 68 to the sensor need not pass through any additional interfaces between interface 68 and the sensor. Minimizing the number of interfaces, in turn, reduces spurious reflections and glare in the image. Moreover, the focusing effect of the optical system as a whole is enhanced by filling the space between refractive interface 68 and the front surface of the sensor.

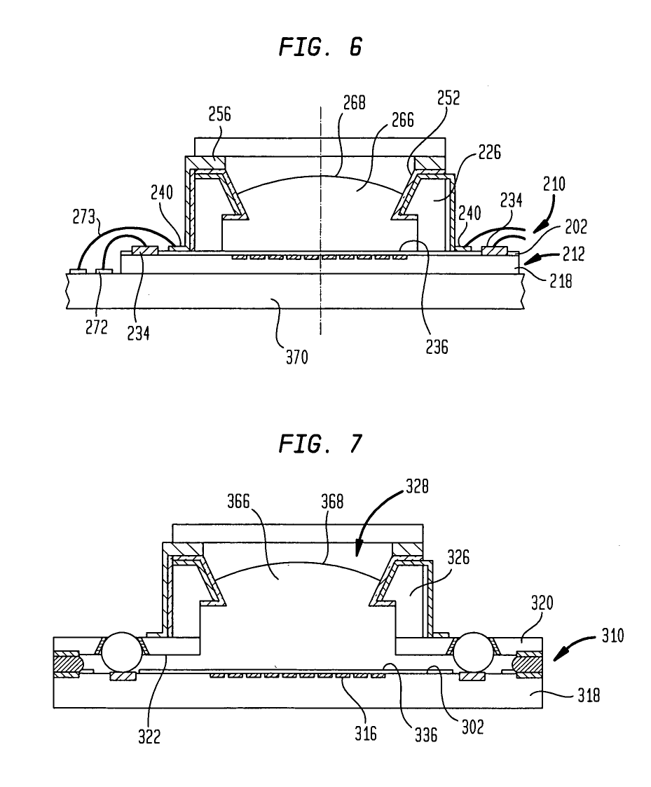

In the absence of an applied electrical potential between electrodes 52 and 56, the shape of the meniscus is determined entirely by the wetting properties of the liquids, and accordingly may have a shape such as that shown at 68′ in FIG. 1. However, when opposite voltages are applied on electrodes 52 and 56, the aqueous liquid 64 becomes electrically charged with a voltage opposite to that prevailing on electrode 52. As schematically indicated in FIG. 3, the opposite charges in fluid 64 and on electrode 52 attract one another, thereby causing the aqueous liquid to extend further down the sloping wall 50. Stated another way, the intersection between the meniscus 68 and the sloping wall moves down the sloping wall. This action alters the shape of the meniscus and hence the shape of the refractive interface, so that the refractive interface has the configuration as shown in solid lines at 68 in FIGS. 1 and 3. The extent of this effect depends upon the applied voltage, so that by varying the voltage, the meniscus can be brought to intermediate shapes between that shown in 68′ and that shown in solid lines at 68. Because the shape of the refractive interface changes, the optical properties also change with the applied voltage. Typically, a maximum operating voltage on the order of 50-100 volts is used for a practical lens system with a practical variable focus. However, because the device operates by electrostatic attraction, it does not require a current flow during operation. From an electrical point of view, the device functions as a capacitor, with electrode 56 and aqueous fluid 64 constituting one plate, and with electrode 52 constituting the opposite plate. Thus, once a charge is applied, the only current required is that necessary to compensate for leakage, if any, through dielectric layer 54, or through other components of the system.

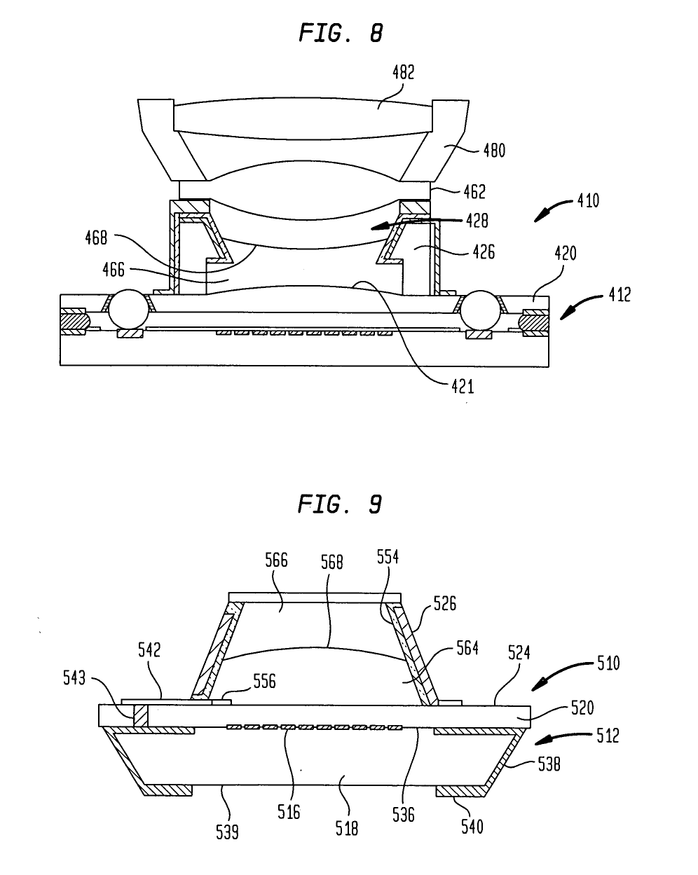

The module discussed above with reference to FIGS. 1-3 can be mounted readily on a circuit panel. For example, as shown in FIG. 4, the module is mounted on a circuit panel 70 with terminals 40 engaged with and bonded to electrically conductive pads 72 on a surface of the circuit panel, and with the front face 14 of the sensor (the outer face 24 of cover 20) facing towards the circuit panel. The container 26 extends through a hole 74 in the circuit panel, so that the container extends to the opposite site of the circuit panel, i.e., the side of circuit panel 70 facing upwardly in FIG. 4. This arrangement provides a relatively compact, low-height mounting. Most preferably, terminals 40 are adapted for surface-mounting to the pads 72 of the circuit panel. Thus, terminals 40 may include a solder or may be wettable by a solder, so that the entire module can be mounted to the circuit panel simply by solder-bonding the terminals to the pads of the circuit panel. By surface-mounting the module to the circuit board and connecting at least some of the terminals 40 to contact pads of the circuit board, the chip 18 is connected to those elements of the circuit which interact with the chip, as, for example, power, ground, timing and data connections, so that the chip can function as an element of a larger circuit. Moreover, the same step also serves to connect terminals 40c and 40d, associated with the electrodes which act to control the meniscus and hence control the variable focus. The particular contact pads associated with these electrodes typically are connected to ground and to a power supply capable of providing the desired control voltages.

In a further variant (not shown), the module may include a transformer-type or other voltage-converting device physically mounted to the sensor or to the container wall 26 and electrically connected between the terminals associated with the variable focus element and the electrodes. In such an arrangement, a relatively low voltage, as, for example, 0-5 volts, is supplied through the terminals, and this voltage is converted to the necessary driving voltage for application to the electrodes. This limits the voltages which must be applied to the conductors of the circuit panel and hence simplifies the design of the circuit panel. Moreover, providing the voltage converter and the other elements of the variable focus lens and sensor in a single structure minimizes the number of components which must be handled, ordered and processed by the system's manufacturer. Additionally, this approach also permits testing of the complete assembly including the sensor and the variable focus lens, together with the voltage converter, prior to assembly with a circuit board or other circuit panel, thereby minimizing the need for rework of completed assemblies and improving outgoing product quality. A particularly preferred voltage converter includes a piezoelectric transformer as described in the co-pending, commonly assigned U.S. Patent Application filed of even date herewith and naming Giles Humpston as inventor, entitled “LIQUID LENS WITH PIEZOELECTRIC VOLTAGE CONVERTER,” the disclosure of which is hereby incorporated by reference herein, a piezoelectric voltage converter includes two piezoelectric elements mechanically linked to one another, so that when an input voltage is applied to one element, the resulting deformation is applied to the other element, which produces the output voltage. The ratio of output voltage to input voltage is set by the shapes and poling directions of the elements.

The optical elements used in conjunction with the sensor may include additional lenses, filters and the like. For example, the proximal refractive interface 68 formed by the meniscus typically has a relatively small diameter and hence a relatively small aperture. It is, therefore desirable to provide an additional focusing lens 82 disposed forwardly or distally from the proximal refractive interface, so that light passing towards the assembly first passes through the additional focusing lens, which concentrates the light into the diameter of the proximal refractive interface 68. It is desirable to provide good alignment between the various optical elements. For example, the optical axis of lens 82 desirably is precisely parallel with and aligned with the optical axis of the refractive interface 68, i.e., the central axis 30 of the bore. The turret 80 holding such additional optical elements desirably is engaged directly with a feature of sensor 10 or container 26, as, for example, with the front surface 14 of the sensor or with a surface of chip 18. As disclosed in co-pending, commonly assigned U.S. patent applications Ser. No. 11/121,434, filed May 4, 2005, and Ser. No. 11/265,727, filed Nov. 2, 2005, the disclosures of which are hereby incorporated by reference herein, turret 80 may have features 86 which rest on the front surface 14 of the sensor, i.e., on the outer surface of cover 20. These features may pass through additional openings 88 in the circuit panel. Although only one additional optical element or lens 82 is depicted in FIG. 4, it should be appreciated that as many optical elements as desired may be mounted on the same turret.

A fabrication process according to one embodiment of the invention for fabricating the module discussed above begins with a wafer element 118 incorporating numerous chips 18 of the type discussed above. Wafer element 118 may be a complete wafer used during fabrication of the chips or a portion of such a wafer. In a further arrangement, wafer element 118 may include separate chips mounted to a common substrate (not shown) in predetermined positions relative to one another. A cover element 120 including numerous covers 20 of the type discussed above, each having the container wall 26 and associated electrodes and dielectric layer, is also provided. The cover element is assembled with the wafer element, thereby positioning the containers 26 in alignment with the sensitive elements 16 of the various wafers. Seals 44 are formed at the boundaries between adjacent chips 18. The process of forming these seals may be conducted concomitantly with the process of forming electrically conductive feed-throughs 38. For example, where feed-throughs 38 include a solder, the wafer element 118 may include metallic strips 119 extending along the boundaries between adjacent chips, and the cover element 120 may have similar metallic strips. The seal may be formed by introducing solder, so that the solder wets these metallic elements. In other arrangements, the seals may be formed by introducing a non-metallic sealant. Techniques for applying cover elements to wafers are disclosed in co-pending, commonly assigned U.S. patent application Ser. No. 10/949,674, filed Sep. 24, 2004; Ser. No. 10/948,976, filed Sep. 24, 2004; and Ser. No. 10/949,575, filed Sep. 24, 2004, the disclosures of which are hereby incorporated by reference herein.

After the cover element is assembled to the wafer element, the individual containers 26 are filled with the aforementioned liquids, and the closures 62 (FIG. 1) are applied onto the individual containers. After application of the closures, the cover element and wafer element are severed as by cutting along planes 125 extending around the boundaries between mutually adjacent chips 18. The severing operation yields individual modules, each incorporating the component shown above in FIG. 1.

The aforementioned order of steps may be varied. For example, the containers can be filled and covered by the closures 62 prior to assembly of the wafer element and cover element. This alternative is less preferred, however, where relatively high temperatures such as those used in solder reflow are employed for forming the electrically conductive through connections, seals or both. In a further variant, the container filling and closure application steps can be performed after severing the cover element and wafer element.

A module 210 according to a further embodiment of the invention (FIG. 6) is similar to the module 10 discussed above with reference to FIGS. 1-3, except that the sensor 212 does not include a separately formed cover. The sensor body includes a passivation layer 202 forming the front surface 236 of the chip 218, so that surface 236 defines the front surface of the sensor. The container 226 is secured directly onto this front surface as, for example, by adhesive bonding. The contacts 234 serve as some of the terminals of the module. Additional terminals 240 are provided on the passivation layer, or on the body of chip 218 itself. These additional terminals 240 are electrically connected to the electrodes 252 and 256 associated with the variable focus element. Additional terminals 240 may or may not be connected to the internal circuitry of the chip. Here again, the optical path of the refractive interface or meniscus 268 to the front surface of the sensor extends entirely within liquid 266.

Module 210 of FIG. 6 is depicted as being mounted in a “face-up” orientation, with the front surface 236 of the sensor and container 226 facing away from a circuit panel 370, and with terminals 234 and 240 connected to conductive elements 272 on the circuit panel by leads such as wire bonds 273. Here again, a turret or other structure can be mounted over the unit to provide additional optical elements. The same arrangement can be used for mounting the other units discussed herein, as, for example, the units 10 shown in FIG. 1.

A unit 310 according to yet another embodiment of the invention (FIG. 7) is similar to the unit discussed above with reference to FIGS. 1-3, except that the cover 320 has a hole in it so that a portion of the chip front surface 336 in the vicinity of sensitive elements 316 is exposed. This exposed portion of the front surface constitutes a part of the front surface of the sensor. Here again, the chip desirably is provided with a transparent passivation layer 302. In this arrangement, the bore 328 defined by the container wall 326 continues through cover 320, to the inner surface 322 of the cover. The space within bore 328, thus, communicates with the space between the cover 320 and chip 318, so that one of the liquids 366 which constitutes the refractive interface or meniscus 368 fills the space between chip 318 and cover 320.

A unit 410 according to a further embodiment of the invention is generally similar to the unit described above with reference to FIGS. 1-3. However, the closure 462 which covers the distal end of bore or space 28 is itself a lens with refracting power and acts in conjunction with the meniscus or variable refractive interface 468. Moreover, a turret 480 is formed by a continuation of the container wall 426. This turret holds one or more additional optical elements such as lenses 482. The same arrangements may be employed in the other embodiments discussed herein. Additionally, cover 420 of sensor 412 includes a lens 421. Lens 421 is in contact with liquid 466, one of the liquids which defines variable interface or meniscus 468.

A unit 510 according to yet another embodiment of the invention (FIG. 9) includes a sensor 512 incorporating a semiconductor chip 518 having sensitive elements 516 on a chip front surface 536, and having “wraparound” leads 538 which extend from the chip front surface to terminals 540 on the opposite rear surface 539 of the chip. Here again, the sensor includes a cover 520 or a passivation layer. In this embodiment, the container wall 526 is formed as a self-supporting metallic structure with the dielectric layer or coating 554 covering the entire interior surface of this structure. Thus, container structure 526 serves in its entirety as one of the electrodes. The opposite electrode 556 is provided as a flat pad on the front surface of the sensor. Also, in this arrangement, the electrically conductive liquid 564 lies closest to the sensor, whereas the non-conductive liquid or oil 566 lies remote from the sensor, on the opposite side of meniscus 568. Electrode 556 is electrically isolated from electrode 526, but is connected to one or more of the wraparound leads 538, as, for example, by a trace 542 and a through conductor 543 extending through the cover. The opposite electrode 526 may be connected to one of the wraparound electrodes 538 in a similar manner. Alternatively, one or both of the electrodes may be connected to specialized wraparound leads which extend onto the outer surface 524 of the cover, rather than between the cover and chip 518, as depicted in FIG. 9. The other wraparound leads are connected to the internal circuitry (not shown) within chip 518. Chips with wraparound leads of this type are known in the art; such chips are disclosed, for example, in U.S. Pat. No. 6,646,289 and, therefore, are not described further herein. Assemblies of this type can be mounted in a face-up configuration, with container 526 pointing away from a circuit panel, as, for example, by surface-mounting terminals 540 to a circuit board. The configuration of the container depicted in FIG. 9 can be used in the other embodiments discussed above.

A module according to a further embodiment of the invention (FIG. 10) includes a solid element 662 rather than a liquid in contact with liquid 666. The solid element 662 and liquid 666 cooperatively define a fixed-configuration proximal refractive interface 668. Here again, liquid 666 extends from the refractive interface to the front surface 614 of the sensor. This embodiment omits the variable-focus capabilities of the modules discussed above, but still provides the enhanced optical performance associated with the liquid filling the space between the refractive interface and sensor.

Numerous variations and combinations of the features discussed above can be utilized without departing from the invention. Merely by way of example, each unit may include a multiplicity of refractive meniscus interfaces in series, as, for example, a layer of an aqueous liquid forming a first meniscus with a layer of an oil immiscible with the first liquid, followed by a layer of a third liquid which is immiscible with the wall and desirably also immiscible with the aqueous liquid.

Unless otherwise specified, elements which are referred to herein as “connected” to one another, “attached” to one another, “mounted” to one another in those terms or in terms of similar meaning need not be directly connected, mounted or attached to one another, but may also be connected, mounted or attached to one another through intermediate structures intervening between the specified elements.

As these and other variations and combinations of the features discussed herein can be utilized without departing from the present invention, the foregoing description of the preferred embodiments should be taken by way of illustration rather than by way of limitation of the invention as defined by the claims.

1. A camera module comprising:
(a) an optoelectronic sensor including a body having a front surface and an array of optically sensitive elements arranged so that light impinging on said front surface will pass to said optically sensitive elements; and
(b) a lens assembly including a first liquid in contact with said front surface of said body.

2. A camera module as claimed in claim 1 further comprising an element having index of refraction different from the index of refraction of said first liquid forming a proximal refractive interface with said first liquid.

3. The camera module of claim 2 wherein said element includes a second liquid having an index of refraction different from said first liquid, said first and second liquids forming a meniscus therebetween, said meniscus constituting said proximal refractive interface.

4. The camera module of claim 3 further comprising electrodes in proximity to said first and second liquids, said electrodes and said liquids being arranged so that the curvature of said meniscus can be altered by varying an electrical potential between said electrodes.

5. The camera module of claim 4 further comprising a container having a container wall defining a space extending to said front surface and a closure extending across said space remote from said front surface, said first and second liquids being disposed within said space with said first liquid in contact with said front surface of said sensor body and said second liquid in contact with said closure.

6. The camera module as claimed in claim 4 further comprising an additional lens, said proximal refractive interface being disposed between said additional lens and said front surface of said optoelectronic sensor.

7. The camera module of claim 2 wherein said body of said optoelectronic sensor includes a semiconductor chip incorporating said sensors and a transparent cover overlying said chip and defining said front surface.

8. The camera module of claim 7 wherein said cover has an inner surface facing toward said chip and an outer surface facing away from said chip, the module further comprising a container wall projecting from said outer surface and extending away from said chip, said container wall and said cover defining a space, said first liquid being disposed within said space.

9. The camera module of claim 8 wherein said second element includes a second liquid disposed within said space, said second liquid having an index of refraction different from said first liquid, said liquids forming a meniscus therebetween, said meniscus constituting said proximal refractive interface, the module further comprising electrodes in proximity to said first and second liquids, said electrodes and said liquids being arranged so that the curvature of said meniscus can be altered by varying an electrical potential between said electrodes.

10. The camera module of claim 9 wherein at least one of said electrodes is mounted to said container wall.

11. The camera module of claim 9 wherein said container wall is integral with said cover.

12. The camera module of claim 9 or claim 10 or claim 11 further comprising electrically conductive terminals carried by said cover, at least some of said terminals being electrically connected to said chip.

13. The camera module of claim 12 wherein at least one of said terminals is electrically connected to at least one of said electrodes.

14. The camera module of claim 12 wherein said container wall projects in a central region of said front surface and said terminals are disposed in a peripheral region of said front surface outside of said central region.

15. The camera module of claim 14 wherein said terminals are adapted for surface-mounting to a circuit panel.

16. The camera module as claimed in claim 7 wherein said chip includes an active region incorporating said sensing elements and wherein said inner surface of said cover is spaced from said active region of said chip.

17. A camera module comprising:
(a) a structure including:
(i) an optoelectronic sensor including a body having a front surface and an array of optically sensitive elements arranged so that light impinging on said front surface will pass to said optically sensitive elements, said sensor further including circuitry connected to said optically sensitive elements; and
(ii) a container including two immiscible liquids having different indices of refraction and electrodes in proximity to said liquids, said electrodes and said liquids being arranged so that the curvature of said meniscus can be altered by varying an electrical potential between said electrodes, said container being aligned with said sensor so that light passing to said sensor passes through said meniscus; and
(b) terminals mounted to said structure, at least some of said terminals being electrically connected to said electrodes and at least some of said terminals being electrically connected to said circuitry.

18. A module as claimed in claim 17 wherein said terminals are adapted for surface mounting to a circuit panel.

19. A module as claimed in claim 17 wherein said sensor body includes a chip having said sensors and said circuitry and a cover overlying a surface of said chip, and wherein said terminals are carried by said cover.

20. A module as claimed in claim 17 wherein said sensor body includes a chip having said sensors and said circuitry and wherein said terminals are carried by said chip.

21. A method of manufacturing a plurality of camera modules comprising:
(a) assembling a container element including a plurality of containers with a wafer element including a plurality of image sensor chips so that said containers are aligned with sensing elements of said chips; and
(b) filling each of said containers with two immiscible liquids having different indices of refraction to thereby form a meniscus, said meniscus defining a refractive interface; and
(c) severing said container element and said wafer element to thereby form a plurality of individual units, each including one of said image sensor chips and one of said containers.

22. The method as claimed in claim 21 wherein said severing step is performed before filling said containers.

23. The method as claimed in claim 21 wherein said container element includes a plurality of covers, each having an inner surface, an outer surface and a container wall projecting from said outer surface, said assembling step including assembling said covers with said chips so that said covers and chips form sensors having front surfaces defined by said covers, with said container walls projecting from said front surfaces.
